(19) United States
(12) Patent Application Publication
(10) Pub. No.: US 2008/0109169 A1
(43) Pub. Date: May 8, 2008

(54) METHOD AND SYSTEM FOR CHARACTERIZING SEISMIC REFLECTION POINTS

(76) Inventor: Sreekanth Thumrugoti, Hyderabad (IN)

Correspondence Address: MCCORMICK, PAULDING & HUBER LLP, CITY PLACE II, 185 ASYLUM STREET, HARTFORD, CT, 06103, US

(21) Appl. No.: 11/936,554

(22) Filed: Nov. 7, 2007

Related U.S. Application Data
(60) Provisional application No. 60/857,286, filed on Nov. 7, 2006.

(51) Int. Cl. G01V 1/34

(52) U.S. Cl. 702/16

(57) ABSTRACT

A method and system for characterizing a seismic reflection point. The system receives vibratory seismic data corresponding to a plurality of events, calculates a curvature and a reflection point corresponding to each of the plurality of events, and characterizes reflection points according to their corresponding curvatures.

### CROSS REFERENCES TO RELATED APPLICATIONS

This application claims the benefit of provisional application 60/857,286 filed Nov. 7, 2006. The entirety of the provisional application is incorporated by reference herein.

### FIELD OF THE INVENTION

The present invention relates to the field of reflection seismology, more particularly as used in prospecting for subterranean or submarine hydrocarbon deposits or reservoirs.

### BACKGROUND OF THE INVENTION

Seismology refers to the study of how energy, in the form of seismic waves, moves through the earth's crust and interacts differently with various types of underground formations. Earth's crust is composed of different layers, each with its own properties. Seismic waves interact differently with each of these layers.

Reflection seismology uses seismology to estimate the properties of the Earth's subsurface, particularly the presence or absence of hydrocarbon deposits, from measurement of reflected seismic waves. To estimate its valuable but optically invisible contents, researchers have used models. Accepted models range from homogeneous bulk acoustic approximations to more sophisticated asymptotic elastic models (e.g. shear, compressional and converted waves, but no absorption or dispersion), to full viscoelastic modeling, using both computers and physical modeling tanks.

In practice, reflection seismologists use a seismic emitter (e.g. dynamite, a specialized air gun, or a shaker/vibrator machine) to excite seismic waves. The seismic waves are reflected from prominent points on subterranean structures, and signals related to the reflected waves are captured by vibration motion sensors. Specialist software then produces vibratory seismic data from the recorded signals. These data can then be interpreted.

Reflection seismologists historically have interpreted vibratory seismic data to obtain a structural component and a stratigraphic component. The structural component normally was a topographic map showing iso-contour lines of reservoir elevations or travel times. The stratigraphic component was usually a map depicting some property of a layer underlying the structurally mapped surface. Examples of such a property were seismic-travel-time thickness or depth-logged thickness, seismic reflection amplitude, logged porosity, sampled or logged rock type etc.

Early in the art, vibratory seismic data were commonly displayed as side-by-side vertical traces forming a seismic cross-section. Because there is no directional information in a single vertical-component seismic trace, multi-trace analysis allowed the apparent two-way travel time dips of reflecting surfaces to indicate the direction from which the reflected sound wave came. Moreover, in areas with little dip to the strata, the subsurface sound velocity could be estimated by measuring normal move out (NMO) of two-way travel time on sequential traces with increasing source-to-receiver separation. Interpretation accuracy depended on the accuracy of estimated sound velocity and bulk density in the subterranean volume.

Current methods use a computer to model the changing velocity of the sound waves as they travel through different layers of the earth. The seismic traces are displayed in two-dimensional images, called common reflection point (crp) panels, which show multiple reflections of the acoustic waves as they bounce off various strata within vertical slices of the Earth. If the computer velocity model is correct, the imaged events appear as approximately flat lines in the crp panel. If the computer velocity model is incorrect, the event depths vary across the panel and do not appear flat. As part of an iterative velocity estimation process, an expert must visually inspect the panels to pick out event locations manually. The expert's picks are then used as input to refine the velocity model. This process is repeated several times, until the model produces events imaged as flat lines. The corrected panels are combined to obtain a two-dimensional image of the subsurface strata to help geologists determine where to site an offshore drilling platform.

Some techniques use advanced algorithms from the areas of automatic target recognition, computer vision, and signal-image processing to break the traces, as displayed on the crp panel, into small pixels (picture elements) to determine if the data represented within each pixel are part of an event or simply background noise. These techniques, so far as is known, require prior knowledge of known events to be incorporated into the procedure and the results of these kinds of processes are only comparable with those attained by experts.

Three-dimensional vertical seismic profiling (vsp) surveys have also been used in attempts to improve the calculation of reflection points. VSP surveys typically use 10 to 120 Hz sound waves generated by many individual near-surface sources positioned over target area of the earth's surface. Multiple receivers or geophones then make separate digital recordings following each detonation or vibrator sweep. In U.S. Pat. Nos. 5,153,858 and 5,251,184, both to H. A. Hildebrand, a method and apparatus for finding horizons or surfaces in three-dimensional seismic data is disclosed. They involve a variation of a technique for generating horizon structure or amplitude maps from a three dimensional volume of seismic traces. These are consistent with the above-discussed anticlinal theory of petroleum accumulation, in which contoured structure maps are primary tools for selecting drill sites.

U.S. Pat. No. 5,018,112 is for a method for hydrocarbon reservoir identification based on defining aerial boundaries of a hydrocarbon or petroleum fluid reservoir. The '112 patent uses traditionally processed three-dimensional seismic traces in combination with distinctive critical parameter information from a producing well in the area. It is apparently assumed that traditional seismic processing is acceptable. One seeks according to this patent to locate surface-of-the-earth areas at which a drill site might be chosen to find producible hydrocarbons analogous to the key well from which the distinctive crucial parameter was derived.

U.S. Pat. No. 5,383,114 is a method for interpreting a three-dimensional reflection seismic data volume by displaying the color-coded data as two-dimensional cross-sections, whether vertical or horizontal slices, for the purpose of showing the structural dip and strike of subterranean reflection surfaces. These surfaces are considered to separate layers with different quantities of acoustic impedance.

To characterize the reflection points identified from seismic traces, reflection seismologists have commonly employed two theories: anticlinal theory and bright spot theory.

Anticlinal theory identifies structures in which recoverable natural gas and/or petroleum liquids might accumulate. The anticlinal theory is based on the concept that lighter-than-water petroleum fluids are generated in hydrocarbon source-rock layers, deeper than some threshold depth and warmer than some threshold temperature. The fluids then move by buoyant forces to the highest elevation in a porous and permeable reservoir layer (such as sandstone). From there the fluids either seep out to the earth's surface or are blocked from further movement. When blocked, an impermeable layer traps the fluids either at the crest of a three-dimensional structural arch or adjacent to a fault surface along which slipping of strata has occurred, due to the forces within the earth's crust.

The bright spot theory has been used to attempt to directly identify hydrocarbons (usually natural gas) ahead of the drill bit, regardless of the formation mechanism of the trap. It is based on the concept that the lower acoustic velocity and density of a gas in a reservoir produces stronger seismic reflection amplitude than denser oil or water in the same reservoir.

Other than the above bright spot and flat spot techniques, traditional seismic-stratigraphic analysis of prospective reservoir targets has not, so far as is known, consistently reduced drilling risk. The disappointing inabiliity of reflection seismologists to reliably identify and evaluate stratigraphically trapped reservoir targets has been studied and documented. Accurately characterizing the structure or material present at identified reflection points, according to the present invention, is expected to improve the reliability of reflection seismology.

### BRIEF SUMMARY OF THE INVENTION

The present invention receives vibratory seismic data corresponding to a plurality of events, calculates a curvature and a reflection point corresponding to each of the plurality of events, and characterizes reflection points according to their corresponding curvatures.

In a preferred embodiment, vibratory seismic data is obtained from one or more conventional vibration motion sensors through commercially available data acquisition and filtering means. Reflection point locations are calculated from the seismic data using any of several known methods, or using a spacetime interval equation. Calculated spacetime curvature for a target reflection point is then compared to a background curvature determined for all events identified in the exploration area. Calculated spacetime curvature divergent from the background curvature indicates the presence of an anomalous structure at a target reflection point corresponding to that event. In particular, a spacetime curvature significantly less than the most common value or range values indicates the presence of a hydrocarbon deposit or a border of a hydrocarbon deposit at the corresponding reflection point location.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 indicates an exploration area, a seismic emitter, and one or more vibration motion sensors, along with a plurality of reflection points located on subterranean geologic structures that reflect vibratory seismic energy from the seismic emitter to the vibration motion sensors.

FIG. 2 is a block diagram of the system of the present invention as a whole.

FIG. 3 illustrates typical vibratory seismic data.

FIG. 4 illustrates a specially preferred embodiment of the invention in which the seismic emitter and the vibration motion sensors are vehicle-mounted.

FIGS. 5 and 6 are flowcharts of methods followed to identify, from vibratory seismic data, the presence or absence of subterranean resource deposits.

FIG. 7 illustrates the spacetime coordinate system used to calculate spacetime curvature of vibratory seismic data.

### DETAILED DESCRIPTION OF THE INVENTION

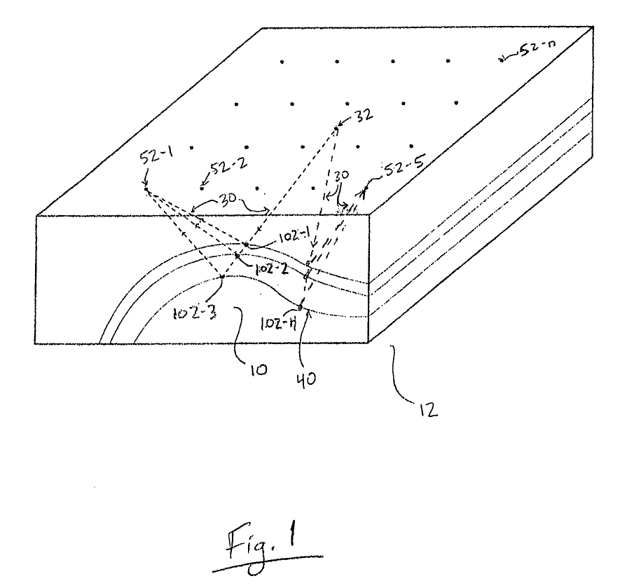

The present invention is used to detect the presence of hydrocarbon deposits or reservoirs underlying an exploration area located on land, under water, or in a land-water transitory zone. Referring to FIG. 1, in a preferred embodiment, the present invention is used to detect the presence of hydrocarbon deposits 10 underlying a land-based exploration area 12.

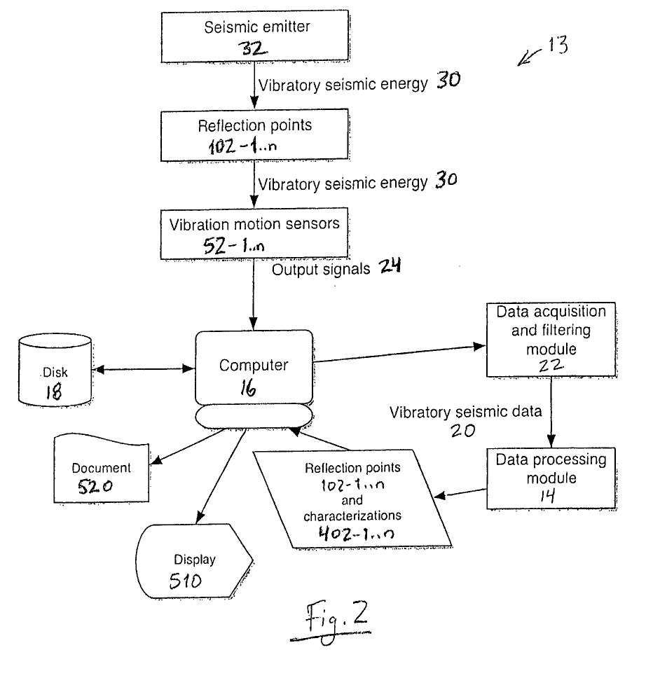

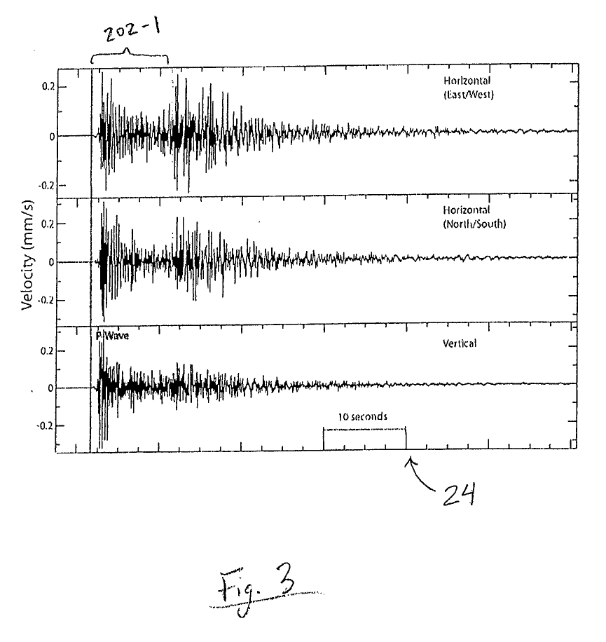

Referring to FIG. 2, the system 13 of the present invention comprises a data processing software module 14 executed by a computer 16 from instructions stored by an computer-readable data storage medium 18 such as a magnetic tape, magnetic disk, optical disk, flash memory, or similar devices known in the art. The data processing software module receives vibratory seismic data 20 corresponding to a plurality of spacetime events 202-1 . . . n as shown in FIG. 3. The vibratory seismic data may be received directly from a data acquisition and filtering module 22, as known in the art, which may preferably be executed by the same computer 16 from instructions stored on the computer-readable data storage medium 18. Alternately, the data acquisition and filtering module 22 may be performed by another computer, using instructions stored on the storage device 18 or in another storage device, or may be accomplished by electronic circuitry without separate software. Optionally, the filtering function of the data acquisition and filtering module may incorporate signal fault detection. Referring also to FIG. 3, the data acquisition and filtering module 22 may produce the vibratory seismic data 20 from raw electrical, electromagnetic, or optical output signals 24 produced by one or more vibration motion sensors 52-1 . . . n. Referring to FIGS. 1 and 2, the one or more vibration motion sensors 52-1 . . . n produce the output signals 24 in response to excitation by vibratory seismic energy 30 transmitted by a seismic emitter 32 and reflected from a plurality of reflection points 102-1 . . . n, etc. of at least one subterranean structure 40 underlying the exploration area.

Alternatively, the vibratory seismic data 20 may be received from a pen-and-ink paper trace, a magnetic tape, magnetic disk, optical disk, flash memory, or similar computer-readable storage media as known in the art. Particularly, the vibratory seismic data 20 may be received from the computer-readable storage medium 18.

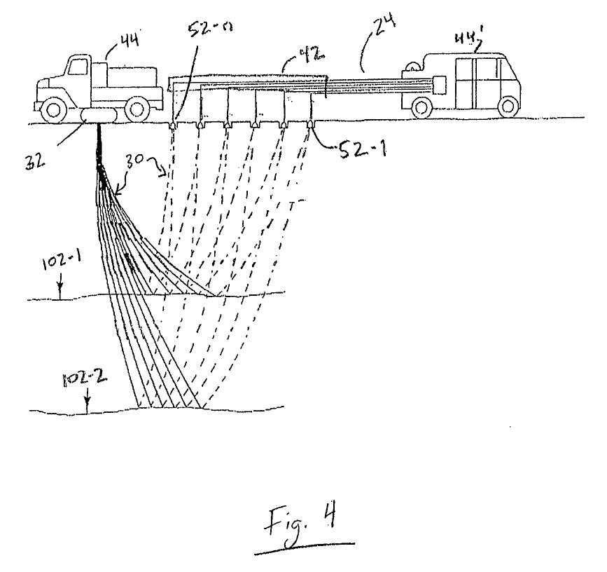

In a specially preferred embodiment of the invention, referring to FIG. 4, the seismic emitter 32 and the one or more vibration motion sensors 52-1 . . . n may be mounted on a base plate 42 operatively connected to a vehicle 44. The vehicle 44 may be a large heavy wheeled or tracked vehicle, specially suitable to carry seismic emitter and vibration motion sensor equipment across varying land terrain. Alternately, the vibration motion sensors 52-1 . . . n may be mounted to a separate, similar vehicle 44′.

Vibration motion sensors 52-1 . . . n may be horizontally polarized vibrators, for example geophones, that produce a positive-going signal when their cases are impulsed toward the direction of the positive axis they represent:
Z is positive downward.
X is positive in the forward direction of the source vehicle.
Y is positive to the right, ninety degrees clockwise from the forward direction.

The vibration motion sensors may be energized both by background seismic energy, which is removed by the filtering means, and particularly by reflected energy from one or more seismic emitters known in the art such as explosives, an air gun, or a vibroseis truck.

In a preferred embodiment of the present invention, the vibratory motion sensors 22 following vibratory seismic data 14 is recorded in x, y and z positive directions:

Displacement

Velocity

Acceleration

Force

Shock

Peak amplitude

Pulse duration

Rise time

Decay time

Frequency spectrum

Shock response spectrum (srs)

It is also possible to capture the vibratory seismic data from electrical, electromagnetic, or optical signals provided by drill-bit mounted accelerometers. In this case the vibratory seismic data 20 may also include the following:

Angular displacement

Angular velocity

Angular acceleration

Torque

The present invention calculates for the plurality of spacetime events 202-1 . . . n a plurality of coordinates according to the following equations:

r=√(xî2+yî2+zî2) (1)

S=√(ĉ2*tî2−rî2) (2)
where x, y and z are represent movement of material point along the three orthogonal axes, ‘c’ is the speed of light, ‘t’ is the difference of time coordinates of the two events, and ‘S’ is the spacetime coordinate of a particular event ‘i’ corresponding to a reflection point.

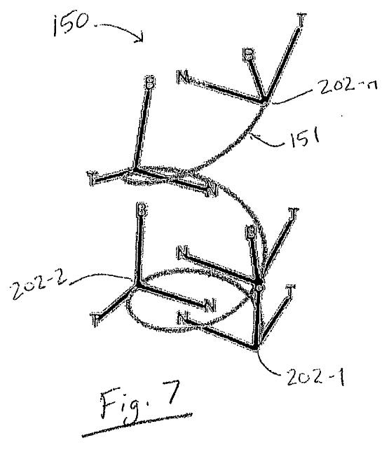

In the spacetime event space, the movements of the geophone mounted point on the surface of earth due to seismic waves will be like the osculating plane defined in FIG. 7 by tangent vector T and normal vector N, where B is the binormal vector.

The tangent unit vector T is defined as

T=dr/ds (3)

The normal unit vector N is defined as

N=(dT/ds)/∥dT/ds∥ (4)

The binormal unit vector B is defined as the cross product of T and N:

B=T×N (5)

From equation (4) it follows, since T always has unit magnitude, that N is always perpendicular to T. From equation (5) it follows that B is always perpendicular to both T and N. Thus, the three unit vectors T, N, and B are all perpendicular to each other. This is called TNB frame. As seismic waves oscillate the surface, the movements of the point where geophone is fixed, within the TNB frame 150, are somewhat like shown in the FIG. 7 with the line 151 tracing the path of spacetime events 202-1 . . . n.

For each spacetime event 202-1 . . . n, the corresponding reflection point 102-1 . . . n may be calculated, accounting for such factors as a seismic signal travel time, a reflection angle 100, and a bulk sound velocity of intervening geologic structures. The calculation of reflection points may be accomplished by the data processing module 14 or by the data acquisition and filtering module 22 using any of a variety of commercially available softwares/techniques. For example, in the wave-front construction principle known as Huygens principle, the successive positions of a wavefront propagating through a medium can be predicted by treating each point on the wavefront as if it were a point source for a new wave front. Alternatively, a single-reflector model may be used in which a planar compressional sound wave travels vertically downward, reflects from a single subterranean surface, and the upward traveling reflected motion is recorded by a uniform grid of geophones embedded in a flat earth surface. In either case, the three-dimensional volume of numbers generated by the traditionally combined recordings represents a two-way travel time volume of reflectivity values representing generally unknown subterranean reflection point positions. Commercial software is effective to calculate the reflection points.

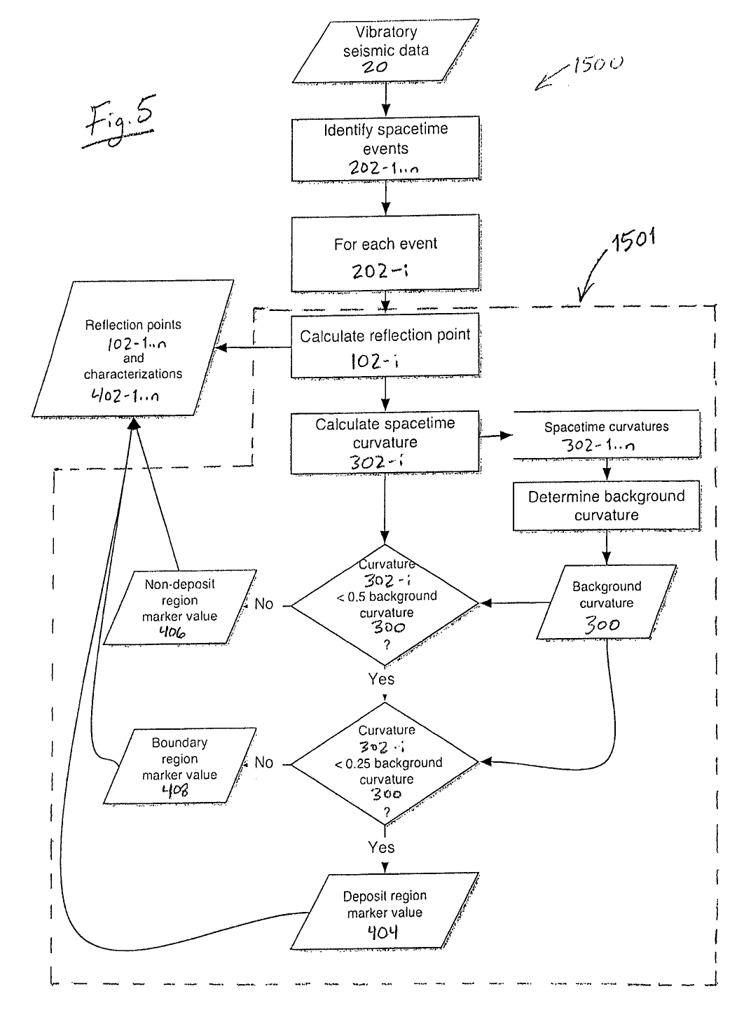

Referring to FIG. 5, the present invention according to process 1500 calculates for each spacetime event 202-i a corresponding reflection point 102-i and a corresponding value of spacetime curvature 302-i. In a preferred embodiment, the spacetime curvature 302-i is calculated according to the following equation:

$$κ = \frac{‖ \begin{matrix}x & y & z \\ {v}_{x} & {v}_{y} & {v}_{z} \\ {a}_{x} & {a}_{y} & {a}_{z}\end{matrix} ‖}{{\vert \sqrt{{v}_{x}^{2} + {v}_{y}^{2} + {v}_{z}^{2}} \vert}^{3}} \qquad ( 6 )$$

where x, y, z are unit vectors; Vx, Vy, and Vz are the velocity components; and ax, ay, and az are the acceleration components along the orthogonal axes.

Among all spacetime events and corresponding reflection points in the exploration area, the present invention then determines a background curvature 300. For example, a suitable background curvature 300 may be the mode, median, or mathematical average value of spacetime curvature. A suitable background curvature might also be determined by the mode, median, or mathematical average of the curvatures for reflection points within one standard deviation from the median reflection point depth. Other alternatives will be apparent to one of skill in the art.

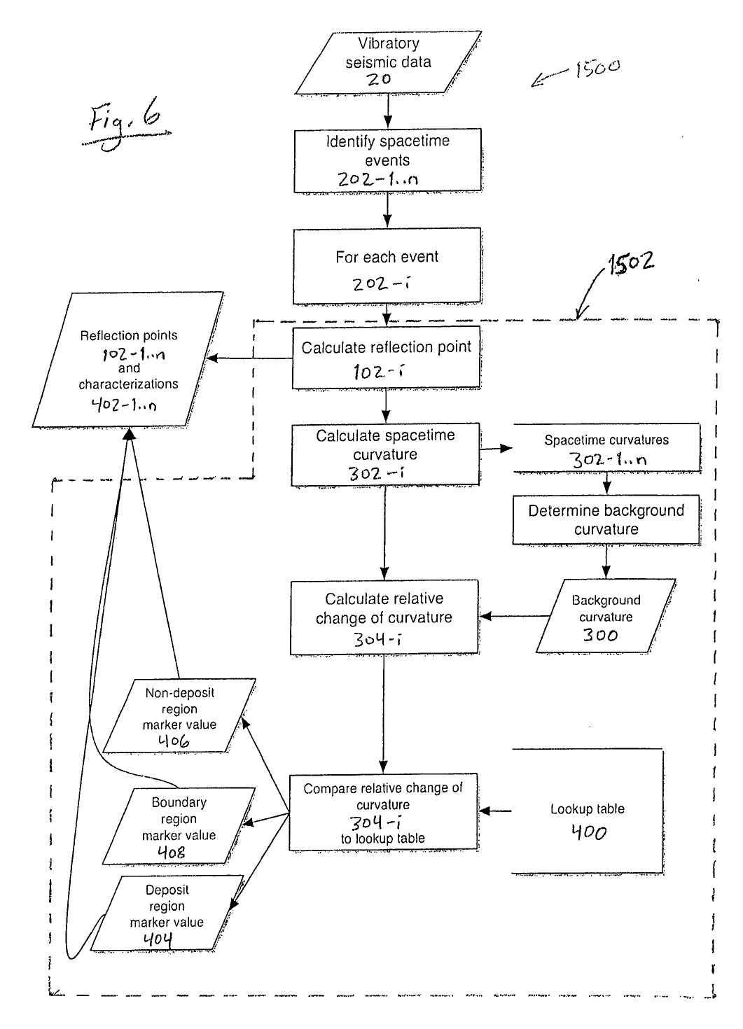

For each reflection point 102-i in the exploration area, the present invention then characterizes the reflection point 102-i based on its corresponding curvature. For example, the present invention may compare the spacetime curvature 302-i corresponding to spacetime event 202-i with the background curvature 300 according to process 1501 as shown at FIG. 5. This comparison may be by a ratio 304-i, by a difference, by a logarithmic relationship, or by any other uniform rule of comparison. Alternately, the present invention may characterize the reflection point 102-i according to process 1502, shown at FIG. 6, by looking up the corresponding curvature 302-i in a lookup table 400.

In an exemplary embodiment of the present invention, lookup table 400 may contain values 404, 406, or 408 corresponding to various ranges of curvature 302-i or of curvature ratio 304-i and indicating, respectively, the presence or absence of a hydrocarbon deposit, or the presence of a hydrocarbon deposit border. Alternately, the present invention may determine such characterizations 402-1 . . . n directly from the spacetime curvatures 302-i without first calculating a relative change of curvature. In another alternate embodiment, the present invention may use the curvatures 302-1 . . . n or the curvature ratios 304-1 . . . n as the characterizations corresponding to reflection points 102-1 . . . n.

In an exemplary embodiment of the invention, a relative change of curvature 304-3 of less than 0.25 corresponds to an anomalous low value of curvature 302-3 indicating the certain presence of hydrocarbons at the reflection point 102-3, while a relative change of curvature 304-2 greater than 0.25 but less than 0.5 corresponds to a moderate low value of spacetime curvature 302-2 indicating that the reflection point 102-2 is on a border of a hydrocarbon deposit, and a a relative change of curvature 304-1 greater than 0.5 indicates the absence of hydrocarbon deposits at the reflection point 102-1.

In another exemplary embodiment of the invention, a spacetime curvature value of 2.38e-18 for event 202-1 corresponding to point 102-1 is the most common value of curvature while a curvature value of 7.52e-19 for event 202-3 indicates the presence of hydrocarbons at reflection point 102-3 and a value of 1.35e-18 indicates a hydrocarbon deposit border region. The lookup table ratios or values may change as a function of the background geology and soil structure in the exploration area. A new lookup table may be determined for each new region of exploration.

Referring to FIGS. 3 and 5, reflection points 102-1 . . . n and the corresponding characterizations 402-1 . . . n indicating hydrocarbon presence 404 or absence 406, or a hydrocarbon deposit border 408, may be recorded on the computer-readable storage medium 18 or on a separate storage medium. In a preferred embodiment of the invention, a electronic display device 510 or a printed document 520 may display reflection points 102-1 . . . n and the corresponding characterizations 402-1 . . . n.

In an alternate embodiment of the present invention, the calculated curvatures may be graphically displayed against the locations of reflection points, using either a 2-D or a 3-D format where curvature values provide a color scale value or an axial coordinate. Then by inspection, a user may identify an anomalous low value of curvature corresponding to the presence of the hydrocarbon deposit at a target reflection point.

Thus, a preferred embodiment of the present invention characterizes the reflection point locations underlying an exploration area, according to the presence or absence of hydrocarbon deposits at the reflection points.

What is claimed is:

1. A method for characterizing a seismic reflection point, comprising the steps of:
receiving vibratory seismic data corresponding to a plurality of events;
identifying a reflection point corresponding to each of at least a portion of the events;
calculating a curvature associated with each of the reflection points;
selecting a target reflection point from the plurality of reflection points;
characterizing the target reflection point based on the curvature associated therewith; and
recording the characterization of the target reflection point.

2. The method according to claim 1, wherein the step of recording the characterization of the target reflection point further includes at least one of:
writing to computer-readable data storage medium a location of the target reflection point and a corresponding value indicating the presence or absence of subterranean resources at the target reflection point;
writing to a paper document a location of the target reflection point and a corresponding value indicating the presence or absence of subterranean resources at the target reflection point; and
displaying a location of the target reflection point and a corresponding value indicating the presence or absence of subterranean resources at the target reflection point.

3. The method according to claim 1, wherein the step of characterizing the target reflection point includes estimating a likelihood as to the presence of subterranean resources at the target reflection point.

4. The method according to claim 3, wherein said subterranean resources are hydrocarbon resources.

5. The method according to claim 1, wherein the step of characterizing the target reflection point further includes determining a background curvature from a plurality of the calculated curvatures aso; and
comparing the curvature corresponding to the selected reflection point with the background curvature.

6. The method according to claim 1, wherein the step of characterizing the selected reflection point further comprises:
determining a background curvature from the plurality of curvatures calculated for each of the identified reflection points; and
calculating a ratio of the calculated curvature corresponding to the target reflection point and the background curvature.

7. The method according to claim 6, wherein the step of characterizing the selected reflection point further comprises the step of:
comparing the ratio of the calculated curvature corresponding to the target reflection point and the background curvature to a predetermined value or range of values.

8. The method according to claim 1, wherein the step of characterizing the target reflection point further includes comparing the calculated curvature corresponding to the target reflection point to a known value or range of values.

9. The method according to claim 1, wherein the step of calculating a plurality of curvatures includes calculating a plurality of spacetime curvatures, according to the formula:
$$κ = \frac{‖ \begin{matrix}x & y & z \\ {v}_{x} & {v}_{y} & {v}_{z} \\ {a}_{x} & {a}_{y} & {a}_{z}\end{matrix} ‖}{{\vert \sqrt{{v}_{x}^{2} + {v}_{y}^{2} + {v}_{z}^{2}} \vert}^{3}}$$
wherein
K is a spacetime curvature corresponding to an event;
x, y, and z are orthogonal unit vectors corresponding to the event;
vx, vy, and vz are orthogonal velocity vectors corresponding to the event; and
ax, ay, and az are orthogonal acceleration vectors corresponding to the event.

10. The method according to claim 1, wherein the step of selecting a target reflection point includes:
identifying a group of reflection points not yet characterized; and
selecting a target reflection point from the group of reflection points corresponding to a reflection point having approximately a lowest calculated curvature among the group.

11. The method according to claim 10, wherein the step of selecting a target reflection point is repeated until a lowest calculated curvature among the group of reflection points not yet characterized is approximately equal to the background curvature.

12. The method according to claim 1, wherein the step of determining a background curvature includes determining a median of a plurality of the calculated curvatures.

13. The method according to claim 1, wherein the step of selecting a target reflection point further includes:
identifying a group of reflection points not yet characterized;
identifying a depth associated with the location of each of the reflection points; and
identifying the reflection point with approximately the greatest depth as the target reflection point.

14. The method according to claim 13, wherein the step of selecting a target reflection point is repeated until the reflection point having a greatest depth in the group not yet characterized is at or above a median depth determined for the plurality of reflection points.

15. The method according to claim 1, wherein the step of selecting a target reflection point is accomplished by performing the step of:
identifying a group of reflection points not yet characterized;
ordering the group of reflection points in accordance with the depth of the location thereof; and
selecting from the group, a target reflection point nearest a median depth determined for the group of reflection points.

16. The method according to claim 1, wherein the step of determining a background curvature includes:
determining a median reflection point depth; and
calculating an average curvature for reflection points within one standard deviation from the median depth.

17. A computer-readable data storage medium having executable instructions stored thereon corresponding to a method for characterizing a seismic reflection point, the method comprising the steps of:
receiving vibratory seismic data corresponding to a plurality of events;
identifying a reflection point corresponding to each of at least a portion of the events;
calculating a curvature associated with each of the reflection points;
selecting a target reflection point from the plurality of reflection points; and
characterizing the target reflection point based on the curvature associated therewith.

18. The computer-readable data storage medium according to claim 17, further including a step of displaying the location of the target reflection point and a value indicating the presence or absence of subterranean resources at the target reflection point.

19. A system for characterizing a seismic reflection point, comprising:
a seismic emitter producing vibratory seismic energy;
a vibration motion sensor positioned for receiving reflected seismic energy produced from said emitter and configured to provide output signals corresponding to said reflected seismic energy;
a data module for receiving said output signals and producing vibratory seismic data corresponding to a plurality of events; and
a processor configured to perform a method comprising the steps of:
receiving vibratory seismic data corresponding to a plurality of events;
identifying a reflection point corresponding to each of at least a portion of the events;
calculating a curvature associated with each of the reflection points;
selecting a target reflection point from the plurality of reflection points; and
characterizing the target reflection point based on the curvature associated therewith.

20. The system according to claim 19, further comprising a step of recording or displaying a location and associate curvature for the target reflection point.
